(19) United States
(12) Patent Application Publication
(10) Pub. No.: US 2006/0278695 A1
(43) Pub. Date: Dec. 14, 2006

(54) Disposable hidden codes for verification of identity

(76) Inventor: Jerry Iraj Yadegar, Los Angeles, CA (US)

Correspondence Address: Jerry I. Yadegar, P.O.Box 251886, Los Angeles, CA, 90025-1886, US

(21) Appl. No.: 11/151,773

(22) Filed: Jun. 14, 2005

(51) Int. Cl. G06K 5/00; G06K 19/06

(52) U.S. Cl. 235/380; 235/494

(57) ABSTRACT

Disposable Hidden Codes DHCs (42) for verification of identity are a plurality of codes (42) randomly selected and sequentially stored in a control center database and linked to an account number (30). A copy of said codes then printed on a card (20) at the same sequential order and hidden under an easy to remove coverer (24). Each account number (28) is to represent one user (32) only. A reliable source (22) such as a bank or governmental agency, after positive identification of a user (32), provides an identification code by which said user (32) is identified in a country, such as Social Security Number in the United States of America, to a DHC control center. The control center assigns an account number (28) for that identification code and provides the DHC card (20) linked to that account number (28) to the reliable source (22) to give to that user (32). To verify said user's (32) identity, said user (32) uncovers the next code (42) and provides it with the account number (28). If said code (42) is found its sequential match in the control center database linked to that account number (28), said user (32) is verified as the owner of said identification code. Each DHC (42) is for one time use only. Considering a DHC account numbers (28) is to be memorized, no harm would come to its user (32) if the said DHC cards (20) along with all its user's (20) valuables including credit cards, licenses, etc. protected under the user's DHC card (20) are lost or stolen. A DHC verification of identity is possible whether the users (32) is present or not and by all communications means including but not limited to the Internet, over the telephone by fax etc. either systematically or through live operator anywhere in the world.

Despite all efforts made to diminish the problem, identity theft still is the fastest growing crime in America, Europe as well as many other countries and there is no sign of slowing down. The fact is, too many databases now holding people's records and personal information and preventing those from falling into wrong hands is seemingly unfeasible.

### PRIOR ART

Biometric technologies, Encryptions, firewalls, PINs and Passwords . . . are commonly used to protect and verify people's identity but all have limitations, vulnerabilities and impracticalities.

Biometric technologies and systems such as fingerprinting, palm scanning, face recognition, irises canning, voice recognition and so forth, link people's records and personal information to their body parts. Such systems are effective for varieties of security applications where the user to be identified is present and his/her biometric file is in a database. To verify an individual's identity on the internet or over the phone however, biometric systems can be easily defeated and many believe it is the invasion of privacy revealing critical information by using such systems.

An individual's fingerprint for example, when scanned is saved in a file and linked to his/her personal information, it is possible for anyone having access to that file to transfer the file over the internet or other suitable communication means claiming to be that person.

Voice recognition systems are somehow effective only when the user to be identified talks and a copy of his/her voice pattern is in a database. Event if said conditions are met, there are electronic devices that can alter voice pattern to fool the system.

It is only a matter of time for computer hackers to break new codes, encryptions and pass through firewalls to gain access to personal information. PINs and Passwords are easy to forget and when reviled become vulnerable to theft.

### DETAIL DESCRIPTION OF THE INVENTION

A Disposable Hidden Code (42) or “DHC” for short is a number, one or more letters, one or more signs, barcode or a combination thereof. A plurality of which (42) randomly selected, preferably by a computer and stored in a database consecutively under a master code (28). Each master code (28) is unique and it is to present one entity only. Master codes (28) may as well be referred to as “account numbers”

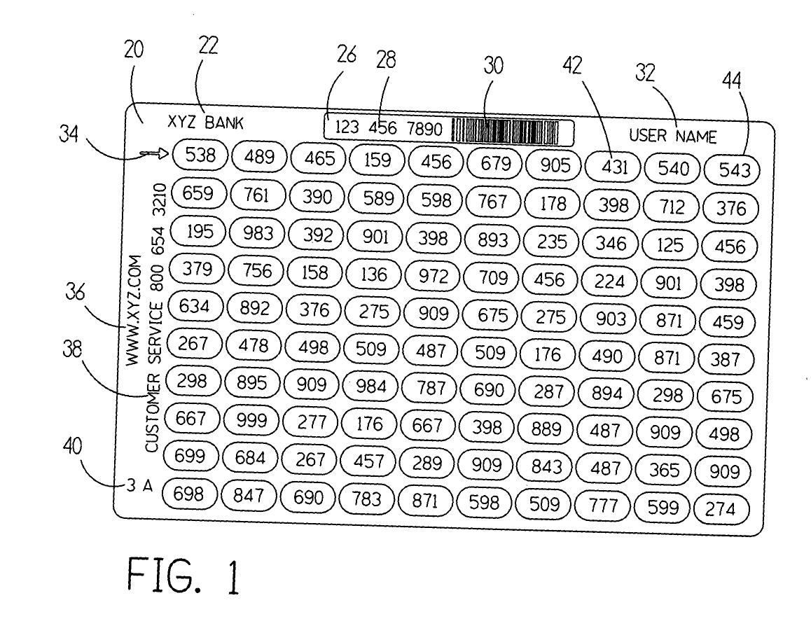

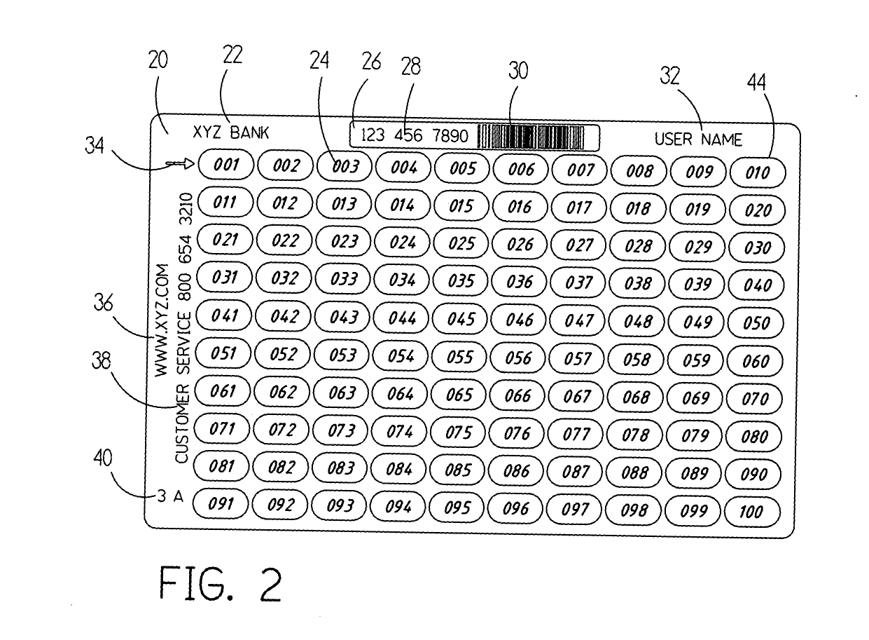

A copy of said DHCs (42) as shown in FIG. 1 then conveyed to an easy-to-carry object preferably a wallet size card (20). Said DHCs as shown in FIG. 2 are concealed (24) in a way to allow each individual code (42) to be revealed consecutively at the time of use. Codes covers (24) preferably are made in a way that will not allow the codes (42) to be re-covered back to its previous position as in scratch or peal to uncover numbers on lottery tickets.

In addition to DHCs (42), said DHC card (20) may include name of a reliable source (22), user's name (32), customer service contact (38), a dedicated web sight (36), an arrow (34) showing the starting point, the card (20) number (40) and its sides and perhaps other suitable information.

The card (20) is to be used by individuals, businesses of all kinds, buyers and sellers of goods and services, groups and organizations, governmental agencies and so forth hereafter “User” (32), without limitations anywhere in the world.

To protect a user's (32) identity, a reliable source (22), such as bank, financial institution, governmental agency etc. provides a unique identification code by which said user (32) is identified in a country, as in Social Security Number or tax ID in the United States of America, to a control center that provides the DHC service. No other information is required unless otherwise specified. The control center then assigns a DHC card (20) with its account number (28) linked to said user's (32) identification code. An identification codes may also be used as an account number, but for security reasons however, it is recommended not to, unless otherwise specified. Said DHC card (20) is provided to the user (32) either directly or through said reliable source (22).

Considering each user (32) is entitled to one account number (28) and its DHC card (20) only, if two reliable sources (22) send an identical identification code to the control center, the center then notifies the two reliable sources (22) to confirm the actual owner of that identification code. If the identification code represents two users, it is obvious that one is posing to be the other. As more users become protected, the system systematically filters out the pretenders.

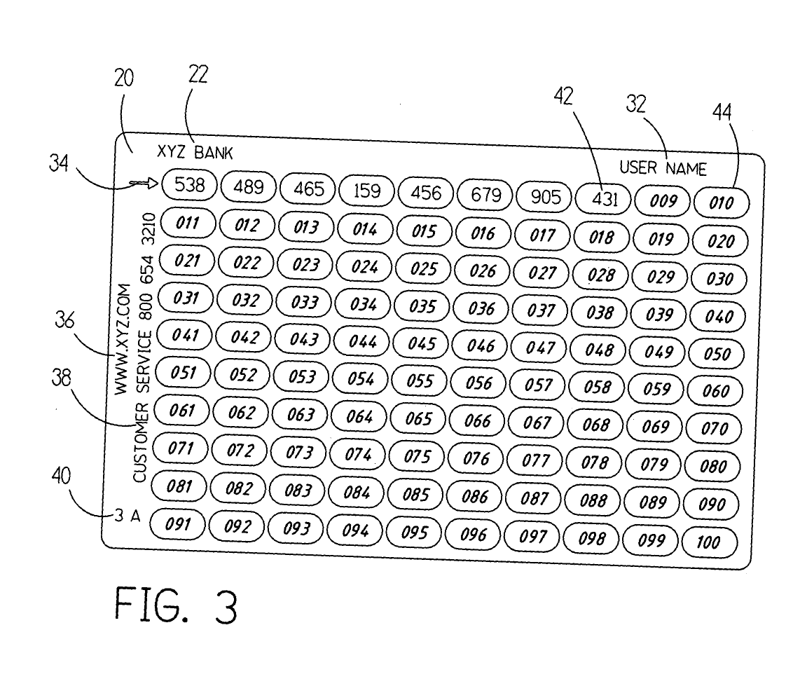

An account number (28) as shown in FIG. 3, preferably, is not to be sown on a DHC card (20), mainly to protect the anonymity of its user (32) if the card (20) is lost or stolen. A removable label (26) for example, may be used to remover the account number (28) after it is known or memorized by its user (32). Since an account number is likely to be digital, it is wise to save it as a phone number perhaps in a cell phone. Considering a DHC card (20) is likely to be carried in a wallet, purse, etc. with other valuables such as driver license, credit cards and so forth, appearance of the user's names (32) on the card (20) will not pose any harm if the user's (32) wallet or purse etc. is lost or stolen.

When a user's (32) identity protected under the DHC system needs to be verified, the user (32) simply uncover the next consecutive DHC (42) and provides it with the account number (28). If said DHC (42) is found under said account number (28) in the control center's database, the user (32) is identified as the owner of said account number (28). Each DHC (42) is to confirm validity of an account number (28) one time only and devaluated thereafter.

Confirmations are possible in varieties of ways including but not limited to the Internet, by telephone, e-mail, fax or any other proper communication means suitable to match account number (28) and DHCs (42) either systematically or through live operators.

All valuables including but not limited to credit cards, identification cards, social security numbers, tax IDs, bank accounts, licenses, permits, badges, passports, green cards, insurances, ownerships and so forth without limitation, can be protected under the DHC system. In practice, when entering a credit card number to purchase a product or service on the Internet for example, the merchant is notified if said credit card is protected under the DCH System. If it is, the user (32) will be asked to provide an account number (28) and a DHC (42) for match. The user (32), then reveals the next DHC (42) and provides it with the account number (28) thereof. The code (42) then enters the control center database looking for its match link to that account number (28). If the match is found the transaction is granted, otherwise declined. Considering each DHC code (42) is good for one time use only, any attempt to use the same code (42) for another transaction would be declined. The same will work anywhere and for any transactions and purposes without limitation where the user's (32) verification of identity is a must whether the user (32) is present or needs be verified on the internet, by telephone, by fax or any other suitable form of communication means.

FIG. 1 shows a DHC card printed on a plurality of three digits numeric codes (42) within appropriate boxes (44), a label (26) printed on an account number (28) in numbers and barcodes a reliable source (22) and a user's name (32).

FIG. 2 is the DHC card (20) of FIG. 1 with all DHC codes (42) concealed (24) and sequentially numbered (24).

FIG. 3 is the DHC card (20) of FIG. 2 showing the card (20) after 8 times verifications of identity and removed label (26).

### REFERENCE NUMBERS

20. DHC card
22. Reliable source
24. Sequential numbers of DHC cover
26. Account number label
28. Account number
30. Account number in barcode
32. User's name
34. Starting point indicator
36. Internet address
38. Customer service number
40. Card number and side
42. DHC
44. Codes frame

1-15. (canceled)

16. A method of identifying a user, comprising:
linking a master code to a plurality of disposable codes;
allowing a source, capable of identifying a user, to assign the master code to a user identification code; and
conveying the master code and disposable codes to an object.

17. The method of claim 16 wherein each of the disposable codes on the object are hidden by a removable cover.

18. The method of claim 17 wherein the removable cover on each of the disposable codes is a material, or composition of materials, that can be scratched off to reveal the disposable code.

19. The method of claim 17 wherein the removable cover on each of the disposable codes is a material, or composition of materials, that can be peeled off to reveal the disposable code.

20. The method of claim 16 wherein the disposable codes on the object comprises numbers, letters, barcodes, signs, or any combination thereof.

21. The method of claim 16 further comprising storing the disposable codes in a database, and providing the disposable codes on the object in a sequence that corresponds to the arrangement of the disposable codes stored in the database.

22. The method of claim 16 wherein the object is a card.

23. The method of claim 22 wherein the card is a wallet size plastic card.

24. The method of claim 16 wherein the user identification code is the user's social security number.

25. The method of claim 16 wherein the user identification code is a code used by a country to identify the user.

26. A method of identifying a user from an object having a plurality of disposable codes linked to a master code, the master code being assigned to a user identification code by a source capable of identifying the user, the method comprising:
receiving one of the disposable codes from the object and receiving the user identification code; and
attempt to verify the identity of the user by determining whether the disposable code received from the object is one of the disposable codes linked to the user identification code.

27. The method of claim 26 wherein the disposable code and identification code are received in response to a request to the user.

28. The method of claim 26 wherein the disposable codes on the object are ranged in a sequence, and wherein the attempt to verify the identity of the user further comprises determining whether the disposable code received from the object is the next in sequence following the last disposable code received from the object to identify the user.

29. The method of claim 28 wherein the disposable codes linked to the master code are stored in a database, the sequence of disposable codes on the object corresponding to the arrangement of the disposable codes stored in the database, and wherein the determination of whether the disposable code received from the object is the next in sequence is based on the arrangement of the disposable codes in the database.

30. The method of claim 26 wherein the user identification code is the user's social security number.

31. The method of claim 26 wherein the user identification code is a code used by a country to identify the user.

32. The method of 26 wherein the user identification code and the disposable code from the object are received over the Internet.

33. The method of claim 26 wherein the user identification code and the disposable code from the object are received by telephone.

34. The method of claim 26 wherein the user identification code and the disposable code from the object are received by fax.

35. A method of using a object to identify a user, the object having a plurality of disposable codes linked to a master code, the master code being assigned to a user identification code by a source capable of identify the user, the method comprising:
providing one of the disposable codes from the object and the user identification and to a control center.

36. The method of claim 35 wherein the user identification code and the disposable code are provided to the control center in response to a request from the control center.

37. The method of claim 35 wherein the disposable codes on the objects are arranged in a sequence, and wherein the disposable code from the object provided to the control center is the next in sequence following the last disposable code from the object provided to the control center to identify the user.

38. The method of claim 37 further comprising determining the disposable code from the object to provide to the control center by identifying the first disposable code in the sequence bidden by a removable cover, and removing the cover to reveal the disposable code to provide to the control center.

39. The method of claim 38 wherein the cover is removed by scratching off a material, or composition of materials, covering the disposable code to be provided to the control center.

40. The method of claim 38 wherein the cover is removed by peeling off a material, or composition of materials, covering the disposable code to be provided to the control center.

41. The method of claim 35 wherein the disposable codes on the object comprises numbers, letters, barcodes, signs, or any combination thereof.

42. The method of claim 35 wherein the user identification number is the user's social security number.

43. The method of claim 35 wherein the user identification code is a code used by a country to identify the user.

44. The method of claim 35 wherein the object is a card.

45. The method of claim 43 wherein the card is a wallet size plastic card.

46. The method of 35 wherein the user identification code and the disposable code from the object are provided to the control center over the Internet.

47. The method of 35 wherein the user identification code and the disposable code from the object are provided to the control center by telephone.

48. The method of 35 wherein the user identification code and the disposable code from the object are provided to the control center by fax.

49. A method of using an object to identify a user, the object having a plurality of disposable codes linked to a master code, the master code being assigned to a user identification code received by a source capable of identifying the user, the user identification code and the master code being linked at a control center to the disposable codes, tire method comprising:
providing one of the disposable codes from the object and the user identification code to the control center; and
attempting to verify the identity of the user, at the control center, by determining whether the disposable code provided from the object is one of the disposable codes linked to the user identification code.

50. The method of claim 49 wherein the user identification code and the disposable code are provided to the control center in response to a request from the control center.

51. The method of claim 49 wherein the disposable codes on the object are arranged in a sequence, and wherein the disposable code from the object provided to the control center is the next in sequence following the last disposable code from the object provided to the control center to identify the user.

52. The method of claim 51 wherein the attempt to verify the identity of the user at the control center further comprises determining whether the disposable code received from the object is the next in sequence.

53. The method of claim 52 wherein the disposable codes linked to the master code are stored in a database, the sequence of disposable codes on the object corresponding to the sequence of the disposable codes stored in the database, and wherein the determination of whether the disposable code received from the object is the next in sequence agrees with the sequence of the disposable codes in the database.

54. The method of claim 51 farther comprising determining the disposable code from the object to provide to the control center by identifying the first disposable code in the sequence hidden by a removable cover, and removing the cover to reveal the disposable code to provide to the control center.

55. The method of claim 54 wherein the cover is removed by scratching off a material, or composition of materials, covering the disposable code to be provided to the control center.

56. The method of claim 54 wherein the cover is removed by peeling off a material, or composition of materials, covering the disposable code to be provided to the control center.

57. The method of claim 49 wherein the disposable codes on the object comprises numbers, letters, barcodes, signs, or any combination thereof.

58. The method of claim 49 wherein the user identification number is the user's social security number.

59. The method of claim 49 wherein the user identification code is a code used by a country to identify the user.

60. The method of claim 49 wherein the object is a card.

61. The method of claim 60 wherein the card is a wallet size plastic object.

62. The method of claim 49 wherein the user identification code and the disposable code from the object are provided to the control center over the Internet.

63. The method of claim 49 wherein the user identification code and the disposable code from the object are provided to the control center by telephone.

64. The method of claim 49 wherein the user identification code and the disposable code from the object are provided to the control center by fax.
